(19) United States
(12) Patent Application Publication
(10) Pub. No.: US 2017/0255316 A1
(43) Pub. Date: Sep. 7, 2017

(54) SPECIFIED POSITION DETECTION UNIT

(71) Applicant: NEWCOM TECHNO INC., Saitama-shi (JP)

(72) Inventor: Kenji TAHARA, Kuki-shi (JP)

(73) Assignee: NEWCOM TECHNO INC., Saitama-shi (JP)

(21) Appl. No.: 14/915,864

(22) PCT Filed: Sep. 30, 2015
(86) PCT No.: PCT/JP2015/077812

§ 371 Date: Mar. 1, 2016

(51) Int. Cl. G06F 3/041; G06F 3/046; G06F 3/044

(52) U.S. Cl. CPC G06F 3/0416; G06F 3/044; G06F 3/046; G06F 3/0412; G06F 2203/04112; G06F 2203/04106

(57) ABSTRACT

Provided is a specified position detection unit that adopts both an electromagnetic induction method and a capacitance method to accept more diverse inputs.

A specified position detection unit including a first input-side axial wire section that is disposed on a predetermined substrate and includes a plurality of axial wire bodies each having an end to which drive current is supplied and another end which is short-circuited, a second input-side axial wire section that is disposed on the substrate on which the first input-side axial wire section is disposed and includes a plurality of axial wire bodies each having an end to which drive voltage is supplied and another end which is open, and a drive section that outputs the drive current to the first input-side axial wire section and the drive voltage to the second input-side axial wire section.

### TECHNICAL FIELD

The present disclosure relates to a specified position detection unit that can be used, for example, in a terminal device having a display surface on which a touch panel is overlaid.

### BACKGROUND ART

Touch panels overlaid on a display surface with which a terminal device is provided are intensively used as means for allowing a user to specify a specific display position on the display surface to readily process information corresponding to the display position.

There has been a known electromagnetic induction touch panel that allows a user to touch a display surface by using what is called a pen-type position specifying tool to cause a plurality of loop coils provided in the display surface to detect the touch position as a position specified by the user (Patent Reference 1). Further, there has been a known a capacitance touch panel that is touched with a pointer, such as a person's finger, so that the pointer is capacitively coupled with a plurality of input-side electrodes for detection of the position specified by the user (Patent Reference 2).

### PRIOR ART REFERENCES

### Patent References

Patent Reference 1: Japanese Patent Laid-Open No. 07-044304

Patent Reference 2: Japanese Patent Laid-Open No. 2010-176571

### SUMMARY OF THE INVENTION

### Problems to be Solved by the Invention

The present disclosure presents a variety of embodiments that provide a specified position detection unit that adopts both an electromagnetic induction method and further presents a capacitance method to accept more various inputs.

### Means Used to Solve the Above-Mentioned Problems

A specified position detection unit according to an embodiment of the present disclosure is characterized by “including a first input-side axial wire section that is disposed on a predetermined substrate and includes a plurality of axial wire bodies each having an end to which drive current is supplied and another end which is short-circuited, a second input-side axial wire section that is disposed on the substrate on which the first input-side axial wire section is disposed and includes a plurality of axial wire bodies each having an end to which drive voltage is supplied and another end which is open, and a drive section that outputs the drive current to the first input-side axial wire section and the drive voltage to the second input-side axial wire section.”

A specified position detection sensor according to an embodiment of the present disclosure is characterized by “including a first input-side axial wire section that is disposed on a predetermined substrate and includes a plurality of axial wire bodies each having an end to which drive current is supplied (*1) and another end which is short-circuited, and a second input-side axial wire section that is disposed on the substrate on which the first input-side axial wire section is disposed and includes a plurality of axial wire bodies each having an end to which drive voltage is supplied and another end which is open.”

A terminal device according to an embodiment of the present disclosure is characterized by “including a first input-side axial wire section that is disposed on a predetermined substrate and includes a plurality of axial wire bodies each having an end to which drive current is supplied and another end which is short-circuited, a second input-side axial wire section that is disposed on the substrate on which the first input-side axial wire section is disposed and includes a plurality of axial wire bodies each having an end to which drive voltage is supplied and another end which is open, and a drive section that outputs the drive current to the first input-side axial wire section and the drive voltage to the second input-side axial wire section.”

### Advantages of the Invention

The variety of embodiments of the present disclosure allow provision of a specified position detection unit that adopts both an electromagnetic induction method and a capacitance method to accept more various inputs.

### BRIEF DESCRIPTION OF THE DRAWINGS

FIG. 1 is a schematic view of a terminal device 1 according to a first embodiment of the present disclosure;

FIG. 2 is a schematic view showing an example of a display surface of the terminal device 1 in FIG. 1;

FIG. 3 is a block diagram showing the configuration of the terminal device 1 in FIG. 1;

FIG. 4 is an electrical connection diagram showing a detailed configuration of a specified position detection unit 10 in FIG. 3;

FIG. 5 is a conceptual view of an input loop coil and an output loop coil formed in the specified position detection unit 10 in FIG. 3;

FIG. 6 is a conceptual view of X electrodes and Y electrodes for a capacitance method that are formed in the specified position detection unit 10 in FIG. 3;

FIG. 7 is a schematic view of an X-axis wire section contained in the specified position detection unit 10 in FIG. 3;

FIG. 8 is a schematic view of a Y-axis wire section contained in the specified position detection unit 10 in FIG. 3;

FIG. 9 is an enlarged view of the X-axis wire section in FIG. 7;

FIG. 10 is an enlarged view of the Y-axis wire section in FIG. 8;

FIG. 11 shows a specific structure of a specified position detection sensor of the specified position detection unit 10 in FIG. 3;

FIG. 12 is an enlarged view showing another example of the X-axis wire section;

FIG. 13 is an enlarged view showing another example of the Y-axis wire section;

FIG. 14 shows another example of a specific structure of the specified position detection sensor;

FIG. 15 is an enlarged view showing another example of the X-axis wire section;

FIG. 16 is an enlarged view showing another example of the Y-axis wire section;

FIG. 17 shows another example of a specific structure of the specified position detection sensor;

FIG. 18 is a schematic view showing an example of a cross section of the specified position detection sensor of the specified position detection unit 10 in FIG. 3;

FIG. 19 is a schematic view showing another example of a cross section of the specified position detection sensor of the specified position detection unit 10 in FIG. 3;

FIG. 20 is an enlarged view of an X-axis wire section according to a second embodiment of the present disclosure; and

FIG. 21 shows a specific structure of a specified position detection sensor according to the second embodiment of the present disclosure.

### BEST MODE FOR CARRYING OUT THE INVENTION

Embodiments of the present disclosure will be described with reference to the accompanying drawings. Components common through the drawings have the same reference characters.

1. First Embodiment

<Summary of first embodiment of present disclosure>

As a terminal device according to a first embodiment of the present disclosure, a terminal device 1 having a display surface in which a specified position detection unit 10 is so disposed as to be overlaid on a display section 30 will be described below. In the present embodiment, the terminal device 1 is described with reference to a smartphone but, as shall be apparent, is not limited thereto. Other examples of the terminal device may include a tablet-type portable terminal, a mobile telephone, a PDA, a portable game console, a laptop personal computer, a desktop personal computer, a variety of business terminals (such as register, ATM terminal, and a ticket vending machine), a handwritten signature authentication terminal, and a large display apparatus for electronic advertisement. Further, in the present embodiment, the specified position detection unit 10 is described with reference to a case where it is overlaid on the display section 30 but is not, of course, necessarily configured this way. For example, the specified position detection unit is not overlaid on the display section in some cases, for example, as in the case of a specified position detection unit used in a tablet dedicated to a digitizer. The terminal device is therefore also not necessarily so configured that the specified position detection unit is overlaid on the display section.

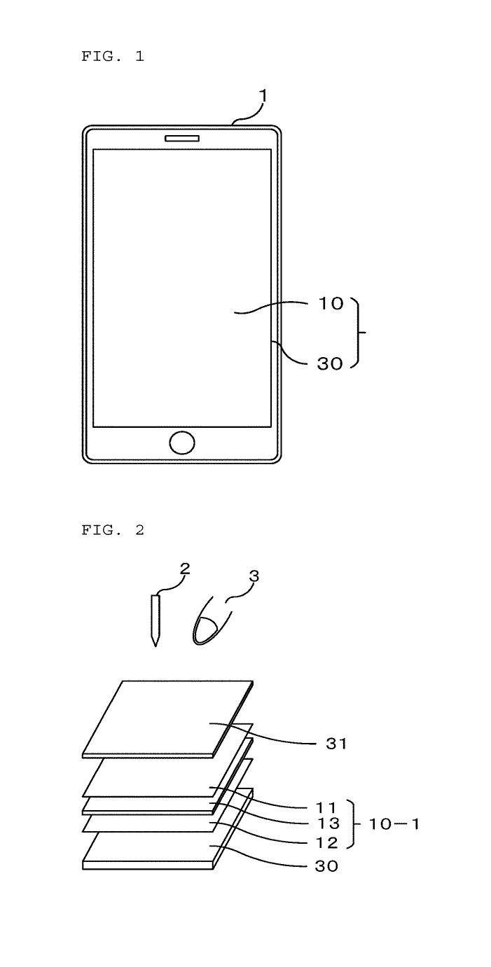

FIG. 1 is a schematic view of the terminal device 1 according to the first embodiment of the present disclosure. According to FIG. 1, the terminal device 1 according to the present embodiment at least includes a display surface having the display section 30 and the specified position detection unit 10 overlaid on the display section 30.

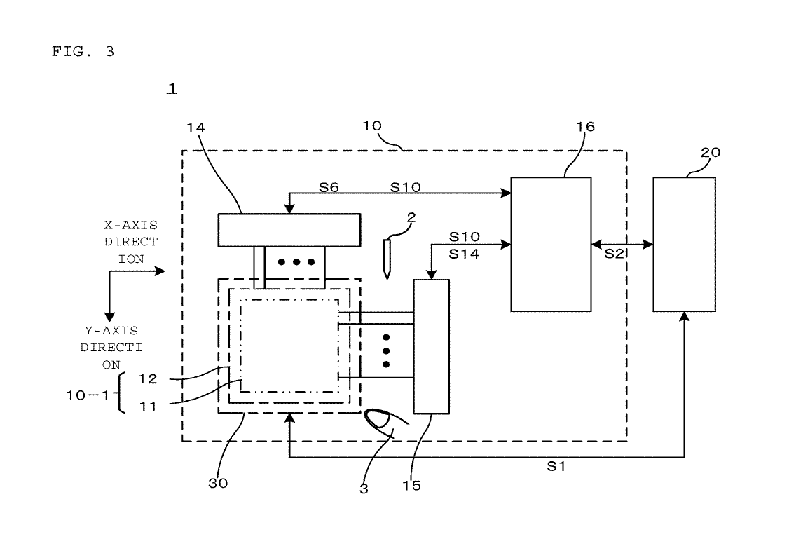

FIG. 2 is a schematic view showing an example of the display surface of the terminal device 1 in FIG. 1. The display surface of the terminal device 1 includes, from bottom to top, the display section 30, a specified position detection sensor 10-1, which includes a Y-axis wire section 12 (input-side axial wire section) disposed on the display section 30, a substrate 13 disposed on the Y-axis wire section 12, and an X-axis wire section 11 (output-side axial wire section) disposed on the substrate 13, and a protective layer section 31, which covers the display section 30 and the specified position detection sensor 10-1. As will be described later, the specified position detection sensor 10-1 along with other components forms the specified position detection unit 10.

In the present embodiment, a user can read information projected from the side where the protective layer section 31 is present and displayed on the display section 30 and specify a displayed specific information material with a pen-shaped position specifying tool 2 grabbed by the user or a pointer 3, such as the user's finger.

In the present embodiment, the specified position detection sensor 10-1, which is overlaid on the upper surface of the display section 30, is formed, for example, of transparent electrodes. As shall be apparent, the specified position detection sensor 10-1 can instead be provided on the lower surface of the display section 30 or in the display section, as in an embedded touch sensor. The terminal device 1 according to the present disclosure can also be used as a tablet dedicated to a digitizer, an electronic blackboard, and other terminal devices. In these cases, the specified position detection sensor 10-1 is not necessarily formed, for example, of transparent electrodes.

In the present embodiment, as the position specifying tool 2, a stylus pen having the shape of a pen will be described. The position specifying tool 2 may be any component as long as an XY-coordinate position specified by the component is detectable by the specified position detection unit 10 according to the present embodiment and does not necessarily have the shape of a pen and is, of course, not limited to a stylus pen.

FIG. 3 is a block diagram showing the configuration of the terminal device 1 in FIG. 1. According to FIG. 3, the terminal device 1 according to the present embodiment includes the specified position detection unit 10, a central processing unit 20, and the display section 30. Although not particularly shown, the terminal device 1 further includes, as required, a storage section formed, for example, of a ROM, a RAM, and a nonvolatile memory, an antenna and a wireless communication processing section for connecting the terminal device 1 to a remotely installed terminal in wireless communication, and a variety of connectors for wiring the terminal device 1 to another terminal. That is, FIG. 3 shows the configuration of the terminal device 1 according to the first embodiment of the present disclosure, but the terminal device 1 does not necessarily include all the components shown in FIG. 3 and can have a configuration in which part of the components is omitted. Further, the terminal device 1 can include other components as well as those shown in FIG. 3.

The specified position detection unit 10 includes the specified position detection sensor 10-1, which is disposed on the upper surface of the display section 30 and includes the Y-axis wire section 12 (input-side axial wire section), the X-axis wire section 11 (output-side axial wire section), and the substrate 13. The substrate 13 can be made of a known insulating material; for example, polyethylene terephthalate (PET), polycarbonate (PC), and any other transparent film material. The specified position detection unit 10, including the X-axis section 11 and the Y-axis section 12, will be described later in detail.

The central processing unit 20 provides the display section 30 with an information display signal S1. The central processing unit 20 further provides a specified position detection controller 16, which forms the specified position detection unit 10, with a variety of control signals to control the overall action of the specified position detection unit 10. The central processing unit 20 further receives, when the user causes the pen-shaped position specifying tool 2 or the pointer (conductor) 3, such as a finger, to touch the XY display surface of the display section 30, a specified position detection signal S2, which represents the touch position as a position specified by the user (*2), from the specified position detection controller 16. The central processing unit 20 processes a variety of types of information on the basis of the received specified position detection signal S2.

The central processing unit provides the specified position detection unit 10 with a control signal (not shown) to switch the operation mode of the specified position detection unit 10 between a mode in which a specified position is detected by using an electromagnetic induction method and a mode in which a specified position is detected by using a capacitance method. When the operation mode is switched to the mode in which a specified position is detected by using an electromagnetic induction method, a drive signal output section 14 outputs drive current to the Y-axis wire section 12. When the operation mode is switched to the mode in which a specified position is detected by using a capacitance method, the drive signal output section 14 outputs drive voltage to the Y-axis wire section 12. The mode switching is performed on the basis of the control signal, as described above, and the mode can also be selected by using a variety of methods, for example, selected by a user or selected in accordance with an application program being executed in the terminal device 1.

The display section 30 displays information on the basis of the information display signal S1 produced by the central processing unit 20 on the basis of image information stored in the storage section (not shown). For example, the display section 30 is formed of a liquid crystal display, and the protective layer section 31 is provided at the outermost level with the specified position detection unit 10 sandwiched between the display section 30 and the protective layer section 31. The protective layer section 31 is made, for example, of glass.

<Specified position detection unit 10>

In the present embodiment, the specified position detection unit 10 includes the specified position detection controller 16, the specified position detection sensor 10-1, which is formed of the X-axis wire section (output-side axial wire section) 11, the Y-axis wire section (input-side axial wire section) 12, and the substrate 13, the drive signal output section 14, and a position detection signal output section 15.

[1. Specified position detection controller 16]

The specified position detection controller 16 controls, in cooperation with the central processing unit 20, the overall action of the specified position detection unit 10. Specifically, the specified position detection controller 16 provides the drive signal output section 14 and the position detection signal output section 15 with a switching signal S10 to control turning on and off of first signal input switches 51Y and second signal input switches 52Y, which are disposed in the drive signal output section 14, and turning on and off of third signal input switches 61X and fourth signal input switches 62X. The specified position detection controller 16 receives a specified position detection signal S14 from the position detection signal output section 15 and provides the central processing unit 20 with the signal as the specified position detection signal S2.

The switching signal S10 is a signal for controlling the first to fourth signal input switches 51Y, 52Y, 61X, 62X to select axial wire bodies used to form a loop coil for the electromagnetic induction method or select axial wire bodies used as an X-axis electrode and a Y-axis electrode for the capacitance method. The specified position detection controller 16 includes a switch management table (not shown) for selecting axial wire bodies used to form a loop coil for the electromagnetic induction method or selecting axial wire bodies used as an X-axis electrode and a Y-axis electrode for the capacitance method. That is, the specified position detection controller 16 produces the switching signal S10 in accordance with the switch management table to control the turning on and off of the first to fourth signal input switches 51Y, 52Y, 61X, 62X.

[2. X-axis wire section 11 and Y-axis wire section 12]

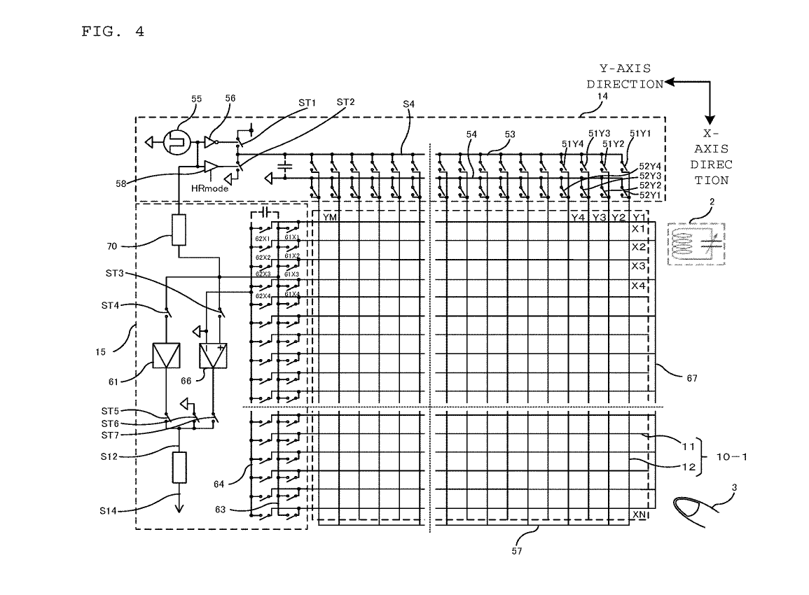

The X-axis wire section 11 and the Y-axis wire section 12, along with the substrate 13, form the specified position detection sensor 10-1. In the specified position detection sensor 10-1, the X-axis wire section 11 functions as an output-side axial wire section in the present embodiment. The X-axis wire section 11 has N (32, for example) X-axis wire bodies X1 . . . XN, which extend roughly linearly in the Y-axis direction in the XY coordinate plane and are disposed roughly parallel to one another at predetermined intervals in the X-axis direction, as shown in FIG. 4.

In the present embodiment, among the X-axis wire bodies X1 . . . XN, predetermined X-axis wire bodies X1, X2, X4, X6 . . . X(N−1), XN each have one end connected to the position detection signal output section 15 via the third and fourth signal input switches 61X, 62X and have the other end connected to or short-circuited with the other ends of the other X-axis wire bodies via a common signal line 67 to provide the position detection signal output section 15 with an induction voltage detection signal. In the present disclosure, an X-axial wire body having one end through which the induction voltage detection signal is outputted and the other end which is short-circuited, such as the X-axis wire bodies X1, X2, X4, X6 . . . X(N−1), XN, is called a “first output-side axial wire body.”

That is, among the X-axis wire bodies X1 . . . XN, at least two of the X-axis wire bodies X1, X2, X4, X6 . . . X(N−1), XN are selected under the control of the specified position detection controller 16 to form an output loop coil used for the electromagnetic induction method.

On the other hand, the remaining X-axis wire bodies X3, X5, X7 . . . X(N−4), X(N−2) each have one end connected to the position detection signal output section 15 via the third and fourth signal input switches 61X, 62X and the other end not connected to the common signal line 67 but being open and formed independent of one another to provide the position detection signal output section 15 with a capacitance detection signal. In the present disclosure, an X-axis wire body having one end through which a capacitance detection signal is outputted and the other end being open, such as the X-axis wire bodies X3, X5, X7 . . . X(N−4), X(N−2), is called a “second output-side axial wire body.”

That is, among the X-axis wire bodies X1 . . . XN, the X-axis wire bodies X3, X5, X7 . . . X(N−4), X(N−2) form individual X-axis electrodes used for the capacitance method under the control of the specified position detection controller 16.

In the specified position detection sensor 10-1, the Y-axis wire section 12 functions as an input-side axial wire section in the present embodiment. The Y-axis wire section has M (20, for example) Y-axis wire bodies Y1, Y2 . . . YM, which extend roughly linearly in the X-axis direction in the XY coordinate plane and are disposed roughly parallel to one another at predetermined intervals in the Y-axis direction, as shown in FIG. 4.

In the present embodiment, among the Y-axis wire bodies Y1 . . . YM, predetermined Y-axis wire bodies Y1, Y2, Y4, Y6 . . . Y(M−1), YM each have one end connected to the drive signal output section 14 via the first and second signal input switches 51Y, 52Y and have the other ends connected to or short-circuited with the other ends of the other Y-axis wire bodies via a common signal line 57 to supply the drive current. In the present disclosure, a Y-axis wire body having one end through which the drive current is supplied and the other end which is short-circuited, such as the Y-axis wire bodies Y1, Y2, Y4, Y6 . . . Y(M−1), YM, is called a “first input-side axial wire body.”

That is, among the Y-axis wire bodies Y1 . . . YM, at least two of the predetermined Y-axis wire bodies Y1, Y2, Y4, Y6 . . . Y(M−1), YM are selected under the control of the specified position detection controller 16 to form an input loop coil used for the electromagnetic induction method.

On the other hand, the remaining Y-axis wire bodies Y3, Y5, Y7 . . . Y(M−4), Y(M−2) each have one end connected to the drive signal output section 14 via the first and second signal input switches 51Y, 52Y and the other end not connected to the common signal line 57 but being open and formed independent of one another to supply the drive voltage. In the present disclosure, a Y-axis wire body having one end through which the drive voltage is supplied and the other end being open, such as the Y-axis wire bodies Y3, Y5, Y7 . . . Y(M−4), Y(M−2), is called a “second input-side axial wire body.”

Specifically, among the Y-axis wire bodies Y1 . . . YM, the predetermined Y-axis wire bodies Y1, Y2, Y4, Y6 . . . Y(M−1), YM form individual Y-axis electrodes used for the capacitance method under the control of the specified position detection controller 16.

The X-axis wire bodies X1 . . . XN and the Y-axis wire bodies Y1 . . . YM, which sandwich the substrate 13 and form the specified position detection sensor 10-1, are so disposed that they intersect each other at right angles. The X-axis wire section 11 and the Y-axis wire section 12 allow identification of an XY-coordinate position on an operation display surface of the protective layer section 31 of the display section 30 on the basis of the intersections of the X-axis wire bodies X1 . . . XN and the Y-axis wire bodies Y1 . . . YM.

[3. Drive signal output section 14]

The drive signal output section 14 is provided on the side facing the one end of the plurality of Y-axis wire bodies that form the Y-axis wire section 12 and outputs a drive pulse signal S4, which is generated by the drive signal output section 14, to the one end of the plurality of Y-axis wire bodies.

Specifically, the drive signal output section 14 includes the first signal input switches 51Y, the second signal input switches 52Y, a common signal line 53, to which the first signal input switches 51Y are connected, a common signal line 54, to which the second signal input switches are connected, an input drive pulse generation circuit 55, which converts the drive pulse signal S4 generated on the basis of a control signal S6 into a rectangular-wave signal and supplies the common signal line 53 with the rectangular-wave signal, an inverter 56, an amplifier 58, and switches ST1 and ST2.

The first signal input switches 51Y are connected to the one end of the Y-axis wire bodies Y1 . . . YM in correspondence with the Y-axis wire bodies. The first signal input switches 51Y receive the drive pulse signal S4, which is generated by the input drive pulse generation circuit 55 on the basis of the control signal S6 and converted by the inverter 56 and the amplifier 58 into a rectangular-wave signal, and supplies each of the Y-axis wire bodies with the drive pulse signal S4 via the common signal line 53.

In the present embodiment, among the Y-axis wire bodies Y1 . . . YM, the Y-axis wire bodies Y1, Y2, Y4, Y6 . . . Y(M−1), YM are used as Y-axis wire bodies that form an input loop coil for the electromagnetic induction method. On the other hand, the remaining Y-axis wire bodies, that is, the Y-axis wire bodies Y3, Y5, Y7 . . . Y(M−4), Y(M−2) are used as Y-axis electrodes for the capacitance method. The first signal input switches 51Y corresponding to the Y-axis wire bodies Y1, Y2, Y4, Y6 . . . Y(M−1), YM, which form an input loop coil for the electromagnetic induction method, and the first signal input switches 51Y corresponding to the Y-axis wire bodies Y3, Y5, Y7 . . . Y(M−4), Y(M−2), which are used as Y-axis electrodes for the capacitance method, are sequentially turned on at a predetermined cycle on the basis of the switch signal S10 supplied from the specified position detection controller 16.

One end of the second signal input switches 52Y is connected to the one end of the Y-axis wire bodies Y1 . . . YM, which is the downstream side of the first signal input switches 51Y, in correspondence with the Y-axis wire bodies. The other end of the second signal input switches 52Y is grounded via the common signal line 54. That is, the second signal input switches 52Y are provided between the one end of the corresponding Y-axis wire bodies and the ground in correspondence with the Y-axis wire bodies. The second signal input switches 52Y are turned on based on the switch signal S10 supplied from the specified position detection controller 16. As a result, second signal input switches 52Y are connected to the Y-axis wire bodies selected by the first signal input switches 51Y and function as a selector for selecting a Y-axis wire body that forms, along with the Y-axis wire body selected by the first signal input switches 51Y, an input loop coil.

In the present embodiment, among the Y-axis wire bodies Y1 . . . YM, the Y-axis wire bodies Y1, Y2, Y4, Y6 . . . Y(M−1), YM are used as Y-axis wire bodies that form an input loop coil for the electromagnetic induction method. On the other hand, the remaining Y-axis wire bodies, that is, the Y-axis wire bodies Y3, Y5, Y7 . . . Y(M−4), Y(M−2) are used as Y-axis electrodes for the capacitance method. Therefore, the second signal input switches 52Y corresponding to the Y-axis wire bodies Y1, Y2, Y4, Y6 . . . Y(M−1), YM used as an input loop coil for the electromagnetic induction method are sequentially turned on at the predetermined cycle on the basis of the switch signal S10, whereas the second signal input switches 52Y corresponding to the Y-axis wire bodies Y3, Y5, Y7 . . . Y(M−4), Y(M−2) keep being turned off.

[4. Position detection signal output section 15]

The position detection signal output section 15 is provided on the side facing the one end of the plurality of X-axis wire bodies that form the X-axis wire section 11 and outputs, when the position specifying tool 2 or the pointer 3 specifies an XY-coordinate position on the specified position detection sensor 10-1, the specified position detection signal S14 corresponding to the specified coordinate position.

Specifically, the position detection signal output section 15 includes the third signal input switches 61X, the fourth signal input switches 62X, a common signal line 63, to which the third signal input switches 61X are connected, a common signal line 64, to which the fourth signal input switches 62X are connected, switches ST3 to ST7, an electromagnetic induction signal output circuit 66 having a differential amplification circuit configuration, and a capacitance signal output circuit 61.

The third signal input switches 61X are connected to the one end of the X-axis wire bodies X1 . . . XN in correspondence with the X-axis wire bodies. The third signal input switches 61X are then connected to a non-inverted input end of the electromagnetic induction signal output circuit 66 having a differential amplification circuit configuration over the common signal line 63 via the switch ST3. The third signal input switches 61X are also connected to the one end of the X-axis wire bodies and select X-axis wire bodies that form an output loop coil on the basis of the switch signal S10 supplied from the specified position detection controller 16.

In the present embodiment, among the X-axis wire bodies X1 . . . XN, the X-axis wire bodies X1, X2, X4, X6 . . . X(N−1), XN are used as X-axis wire bodies that form an output loop coil for the electromagnetic induction method. On the other hand, the remaining X-axis wire bodies, that is, the X-axis wire bodies X3, X5, X7 . . . X(N−4), X(N−2) are used as X-axis electrodes for the capacitance method. The third signal input switches 61X corresponding to the X-axis wire bodies X1, X2, X4, X6 . . . X(N−1), XN, which form an output loop coil for the electromagnetic induction method, and the third signal input switches 61X corresponding to the X-axis wire bodies X3, X5, X7 . . . X(N−4), X(N−2), which are used as X-axis electrodes for the capacitance method, are sequentially turned on at the predetermined cycle on the basis of the switch signal S10 supplied from the specified position detection controller 16.

One end of the fourth signal input switches 62X is connected to one end of the X-axis wire bodies X1 . . . XN, which is the downstream side of the third signal input switches 61X, in correspondence with the X-axis wire bodies. The other end of the fourth signal input switches 62X, along with the ground, is connected to an inverted input end of the electromagnetic induction signal output circuit 66 via the common signal line 64. That is, the fourth signal input switches 62X are connected to the one end of the X-axis wire bodies and selects an X-axis wire body that forms, along with the X-axis wire body selected by the third signal input switches 61X, an output loop coil.

In the present embodiment, among the X-axis wire bodies X1 . . . XN, the X-axis wire bodies X1, X2, X4, X6 . . . X(N−1), XN are used as X-axis wire bodies that form an output loop coil for the electromagnetic induction method. On the other hand, the remaining X-axis wire bodies, that is, the X-axis wire bodies X3, X5, X7 . . . X(N−4), X(N−2) are used as X-axis electrodes for the capacitance method. Therefore, the fourth signal input switches 62X corresponding to the X-axis wire bodies X1, X2, X4, X6 . . . X(N−1), XN used as an output loop coil for the electromagnetic induction method are sequentially turned on at the predetermined cycle on the basis of the switch signal S10 supplied from the specified position detection controller 16, whereas the fourth signal input switches 62X corresponding to the X-axis wire bodies X3, X5, X7 . . . X(N−4), X(N−2) keep being turned off.

<Action of specified position detection unit 10>

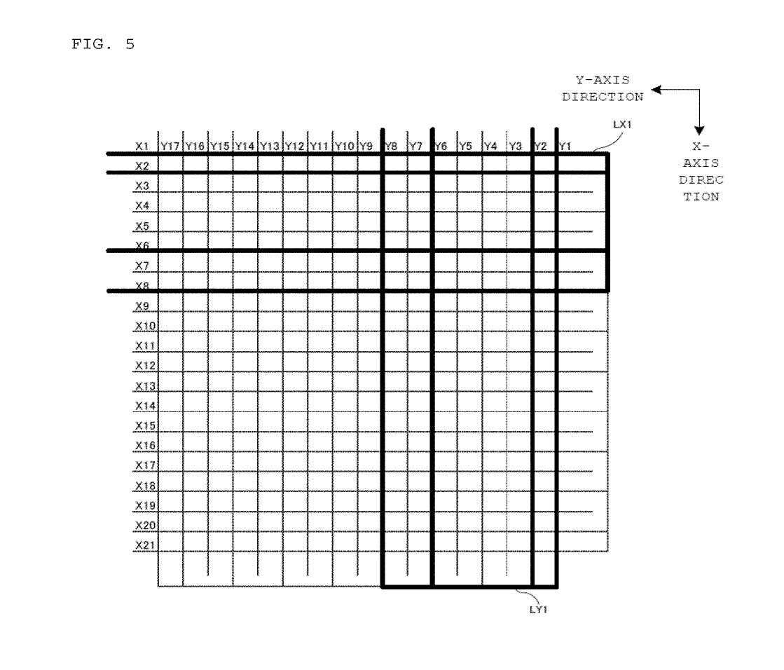

FIG. 5 is a conceptual view of an input loop coil and an output loop coil formed in the specified position detection unit 10 in FIG. 3. Specifically, FIG. 5 shows an example of an input loop coil formed when first signal input switches 51Y and second signal input switches 52Y are turned on and an output loop coil formed when third signal input switches 61X and fourth signal input switches 62X are turned on based on the switch signal S10 supplied from the specified position detection controller 16.

In the example shown in FIG. 5, first signal input switches 51Y1 and 51Y2 for the Y-axis wire body Y1 and the Y-axis wire body Y2 are turned on, and second signal input switches 52Y6 and 52Y8 for the Y-axis wire body Y6 and the Y-axis wire body Y8 are turned on, so that an input loop coil LY1 is formed by the Y-axis wire bodies Y1, Y2, Y6, and Y8. The signal input switches are sequentially turned on and off on the basis of the switch signal S10 supplied from the specified position detection controller 16, so that input loop coils LY2, LY3, and LY4 are sequentially formed and switched from one to another.

Similarly, the switch signal S10 supplied from the specified position detection controller 16 controls turning on and off of the third signal input switches 61X and the fourth signal input switches 62X, so that output loop coils LX1, LX2, LX3, and LX4 are sequentially formed and switched from one to another.

In the present embodiment, the drive signal output section 14 sequentially turns on the first and second signal input switches 51Y, 52Y at a reference detection cycle to sequentially supply the input loop coils LY1, LY2 . . . LYK with the drive pulse signal, that is, the drive current to produce an induction electromagnetic field in the Y-axis wire section 12. The user causes the position specifying tool 2 to touch the XY coordinate plane of the specified position detection sensor 10-1 to specify a coordinate position.

The position specifying tool 2 has a resonance circuit formed of an induction coil and a resonance capacitor. The electromagnetic field produced by the input loop coil LY located in the position where the user causes the position specifying tool 2 to touch the XY coordinate plane of the specified position detection sensor 10-1 therefore causes the induction coil and the resonance capacitor to create tuned resonance current. An induction electromagnetic field produced in the induction coil on the basis of the tuned resonance current induces induction voltage in the output loop coil located in the touch position.

The position detection signal output section 15 then allows the electromagnetic induction signal output circuit 66 to receive an induction voltage detection signal on the basis of the induction voltage induced in the output loop coils LX1

LXL formed by the third and fourth signal input switches 61X, 62X and outputs the detection signal as an induction voltage detection signal S12. The outputted induction voltage detection signal S12 is then outputted as the specified position detection signal S14 via a synchronization detection circuit to the specified position detection controller 16.

On the other hand, in the present embodiment, part of the X-axis wire bodies and Y-axis wire bodies functions as Y-axis electrodes and X-axis electrodes for the capacitance method, as shown in FIG. 6.

Specifically, the Y-axis wire bodies Y3 . . . Y15, which function as Y-axis electrodes and the X-axis wire bodies X3 . . . X19, which function as X-axis electrodes, for the capacitance method form XY coordinate system (Xn, Ym) in which the X axis and the Y axis are perpendicular to each other. An electrostatic field resulting from floating capacitance is thus formed around each of the intersections of the Y-axis wire bodies and the X-axis wire bodies described above.

In the electrostatic field, floating capacitance CZ, which is formed in each grid space of the XY coordinate system around the coordinates (Xn, Ym) of a single intersection between two X-axis wire bodies X(n−1) and X(n+1), which are adjacent to each other and face each other, and two Y-axis wire bodies Y(m−1) and Y(m+1), which are adjacent to each other and face each other, is roughly uniformly created over the XY coordinate system.

In the electrostatic field in the XY coordinate system, when the user touches predetermined position coordinates (Xn, Ym) with the pointer 3, the sum of the floating capacitance values between the specified position and the X-axis wire bodies therearound X(n−1), Xn, X(n+1) and between the specified position and the Y-axis wire bodies therearound Y(m−1), Ym, Y(m+1) is distributed.

In this state, when the drive pulse signal S4, that is, the drive voltage is inputted from the drive signal output section 14 to the Y-axis wire bodies Y3, Y5 . . . Y15, a voltage output corresponding to the floating capacitance value is transmitted to the X-axis wires.

Thereafter, when the first signal input switches 51Y3 . . . 51Y15 in the drive signal output section 14 are sequentially turned on, and when the signal input switches 61X3 . . . 61X19 in the position detection signal output section 15 are turned on, a capacitance detection signal is obtained, and the detection signal is outputted as a capacitance detection signal S13 produced when the pointer 3 touches the coordinates (Xn, Xm) (*3) from the capacitance signal output circuit 61. The capacitance detection signal S13 is sent as the specified position detection signal S14 via the synchronization detection circuit to the specified position detection controller 16.

<Configuration of X-axis wire section (output-side axial wire section) 11>

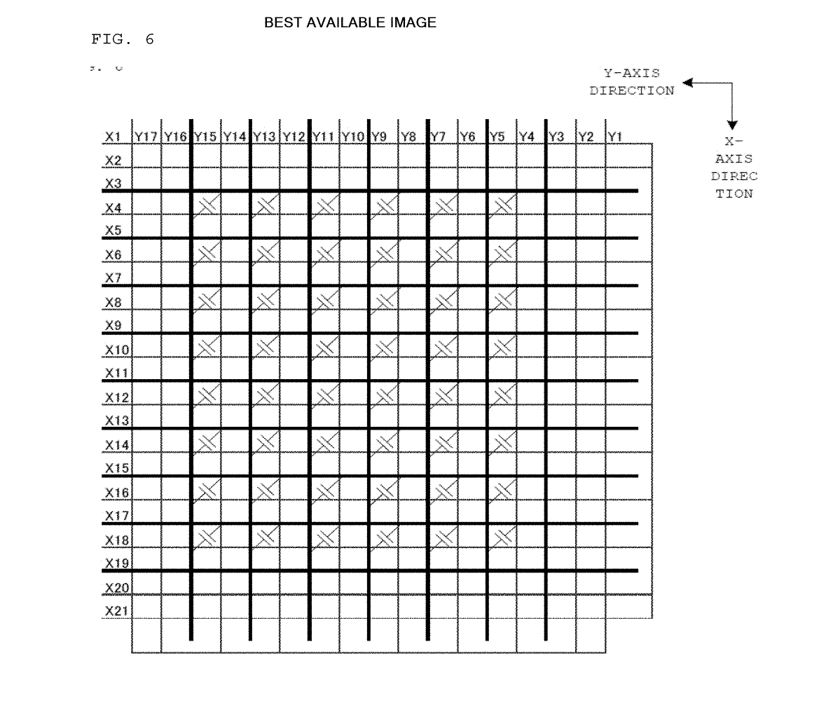

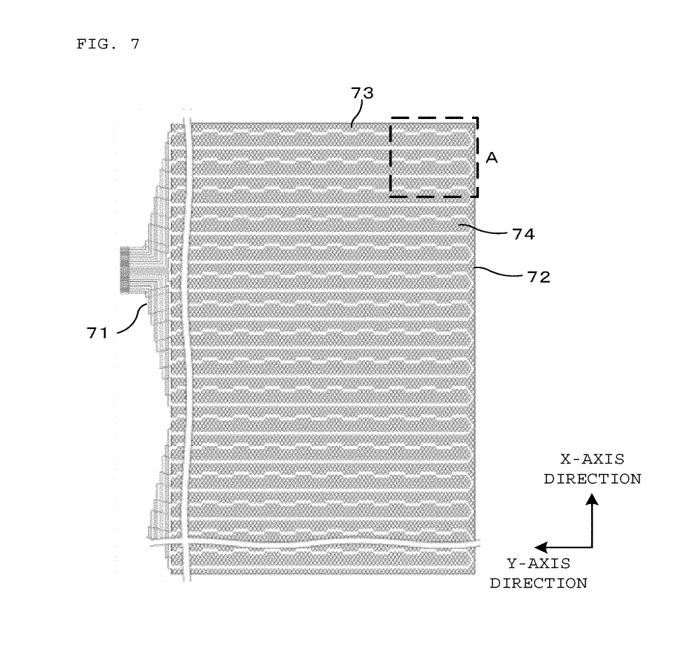

FIG. 7 is a schematic view of the X-axis wire section 11 contained in the specified position detection unit 10 in FIG. 3. More specifically, FIG. 7 shows an example of the X-axis wire section 11, which forms the specified position detection sensor 10-1. In the example shown in FIG. 7, the X-axis wire section (output-side axial wire section) 11 is so configured that X-axis wire bodies 73 for electromagnetic induction are arranged on one surface of the substrate 13 from an end thereof at predetermined intervals roughly linearly in parallel to one another. X-axis wire bodies 74 for capacitance are disposed between two X-axis wire bodies 73 for electromagnetic induction adjacent to each other and roughly linearly in parallel to each other on the same surface of the substrate 13 as the surface on which the X-axis wire bodies 73 for electromagnetic induction are disposed. That is, the X-axis wire bodies 73 for electromagnetic induction and the X-axis wire bodies 74 for capacitance are alternately arranged on the same surface of the substrate 13.

One end of each of the X-axis wire bodies 73 for electromagnetic induction is connected to the position detection signal output section 15 via a routing wire 71, with which the X-axis wire bodies 73 are provided, and the induction voltage detection signal is outputted through the one end to the position detection signal output section 15. On the other hand, the other end of each of the X-axis wire bodies 73 for electromagnetic induction is short-circuited with and connected to the other ends of the other X-axis wire bodies 73 for electromagnetic induction via a common signal line 72.

One end of each of the X-axis wire bodies 74 for capacitance is connected to the position detection signal output section 15 via the routing wire 71, with which the X-axis wire bodies 74 are provided, and the capacitance detection signal is outputted through the one end to the position detection signal output section 15. On the other hand, the other end of each of the X-axis wire bodies 74 for capacitance is not connected to the other ends of the other X-axis wire bodies 74 but forms an open end.

In the present embodiment, although not particularly shown in FIG. 7, an outer circumferential electrode section can be provided along the outer circumference of the X-axis wire section disposed on the substrate 13. The outer circumferential electrode section also has one end connected to the position detection signal output section 15 via the routing wire 71 and the other end connected to the common signal line 72, as the other X-axis wire sections do (*4). The outer circumferential electrode section therefore functions, along with the other X-axis wire bodies 73, as part of the X-axis wire bodies 73 for electromagnetic induction.

Further, although not particularly shown, in the example in FIG. 7, the X-axis wire bodies 73 for electromagnetic induction and the X-axis wire bodies 74 for capacitance are alternately arranged on the substrate 13 (that is, arranged at 1:1), and, as shall be apparent, the arrangement is not necessarily employed. The arrangement of the X-axis wire bodies 73 and 74 can be adjusted as appropriate in accordance with desired detection accuracy and a terminal device to which the present disclosure is applied. For example, one X-axis wire body 74 for capacitance can be disposed every three X-axis wire bodies 73 for electromagnetic induction, or four X-axis wire bodies 74 for capacitance can be disposed every X-axis wire body 73 for electromagnetic induction.

<Configuration of Y-axis wire section (input-side axial wire section) 12>

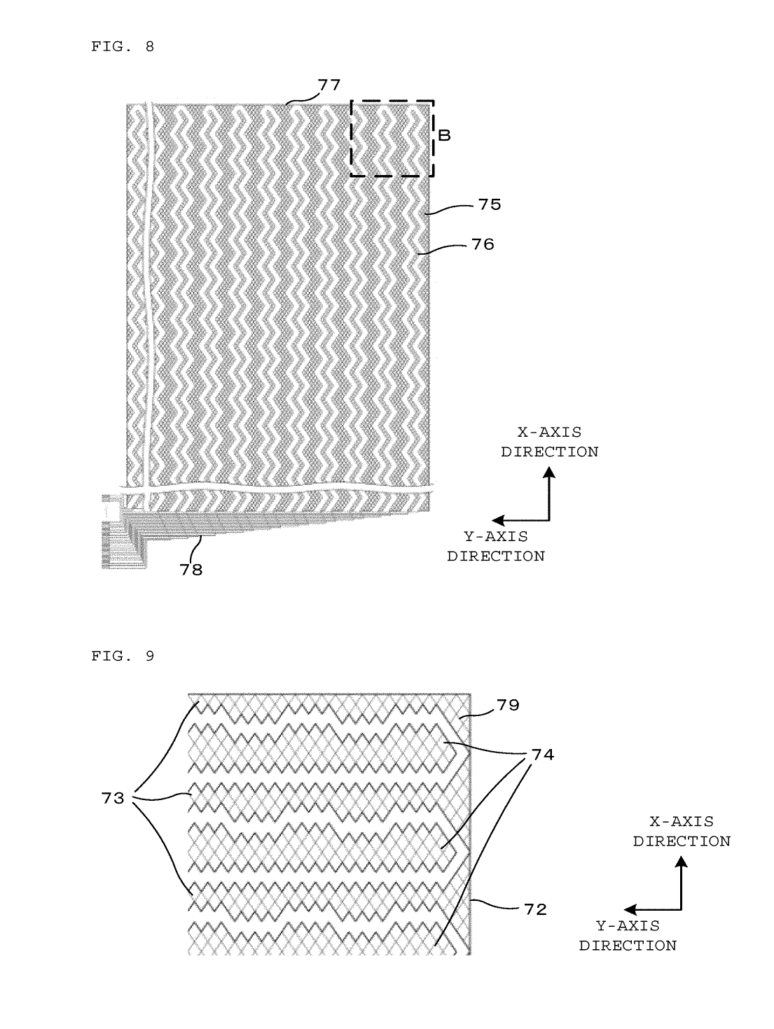

FIG. 8 is a schematic view of the Y-axis wire section 12 contained in the specified position detection unit 10 in FIG. 3. More specifically, FIG. 8 shows an example of the Y-axis wire section 12, which forms the specified position detection sensor 10-1. In the example shown in FIG. 8, the Y-axis wire section (input-side axial wire section) 12 is so configured that Y-axis wire bodies 75 for electromagnetic induction are arranged on the other surface of the substrate 13 from an end thereof at predetermined intervals roughly linearly in parallel to each other. Y-axis wire bodies 76 for capacitance are disposed between two Y-axis wire bodies 75 for electromagnetic induction adjacent to each other and roughly linearly in parallel to each other on the same surface of the substrate 13 as the surface on which the Y-axis wire bodies 75 for electromagnetic induction are disposed. That is, the Y-axis wire bodies 75 for electromagnetic induction and the Y-axis wire bodies 76 for capacitance are alternately arranged on the same surface of the substrate 13.

One end of each of the Y-axis wire bodies for electromagnetic induction is connected to the drive signal output section 14 via a routing wire 78, with which the Y-axis wire bodies 75 are provided, and receives the drive pulse signal generated by the drive signal output section 14, that is, the supplied drive current. On the other hand, the other end of each of the Y-axis wire bodies 75 for electromagnetic induction is short-circuited with and connected to the other ends of the other Y-axis wire bodies 75 for electromagnetic induction via a common signal line 77.

One end of each of the Y-axis wire bodies 76 for capacitance is connected to the drive signal output section 14 via the routing wire 78, with which the Y-axis wire bodies 76 are provided, and receives the drive pulse signal generated by the drive signal output section 14, that is, the supplied drive voltage. On the other hand, the other end of each of the Y-axis wire bodies 76 for capacitance is not connected to the other ends of the other Y-axis wire bodies 76 but forms an open end.

In the present embodiment, although not particularly shown in FIG. 8, an outer circumferential electrode section can be provided along the outer circumference of the Y-axis wire section disposed on the substrate 13. The outer circumferential electrode section also has one end connected to the drive signal output section 14 via the routing wire 78 and the other end connected to the common signal line 77, as the other Y-axis wire sections do (*5). The outer circumferential electrode section therefore functions, along with the other Y-axis wire bodies 75, as part of the Y-axis wire bodies 75 for electromagnetic induction.

Further, although not particularly shown, in the example in FIG. 8, the Y-axis wire bodies 75 for electromagnetic induction and the Y-axis wire bodies 76 for capacitance are alternately arranged on the substrate 13 (that is, arranged at 1:1), and, as shall be apparent, the arrangement is not necessarily employed. The arrangement of the Y-axis wire bodies 75 and 76 can be adjusted as appropriate in accordance with desired detection accuracy and a terminal device to which the present disclosure is applied. For example, one Y-axis wire body 76 for capacitance can be disposed every three Y-axis wire bodies 75 for electromagnetic induction, or four Y-axis wire bodies 76 for capacitance can be disposed every Y-axis wire body 75 for electromagnetic induction.

<Detailed configuration of X-axis wire section (output-side axial wire section) 11>

FIG. 9 is an enlarged view of a region A of the X-axis wire section 11 in FIG. 7. According to FIG. 9, the other end of each of the X-axis wire bodies 73 for electromagnetic induction is connected to and short-circuited with the common signal line 72, whereas the other end of each of the X-axis wire bodies 74 for capacitance forms an open end, as described in FIG. 7.

Further, each of the X-axis wire bodies, both the X-axis wire bodies 73 for electromagnetic induction and the X-axis wire bodies 74 for capacitance, has a mesh-like shape formed of a plurality of grids formed by a plurality of conductive axial wires 79 that intersect each other at predetermined intervals (4.5 μm, for example).

In the example in FIG. 9, an X-axis wire body 73 for electromagnetic induction and an X-axis wire body 74 for capacitance are separate from each other by a distance corresponding to one grid. In the capacitance-based detection, an X-axis wire body 73 for electromagnetic induction located between X-axis wire bodies 74 for capacitance blocks current and therefore lowers the capacitance in some cases. Therefore, to ensure more satisfactory detection sensitivity, the separation distance can be adjusted as appropriate to the distance corresponding, for example, to two grids instead of the distance corresponding to one grid.

<Detailed configuration of Y-axis wire section (input-side axial wire section) 12>

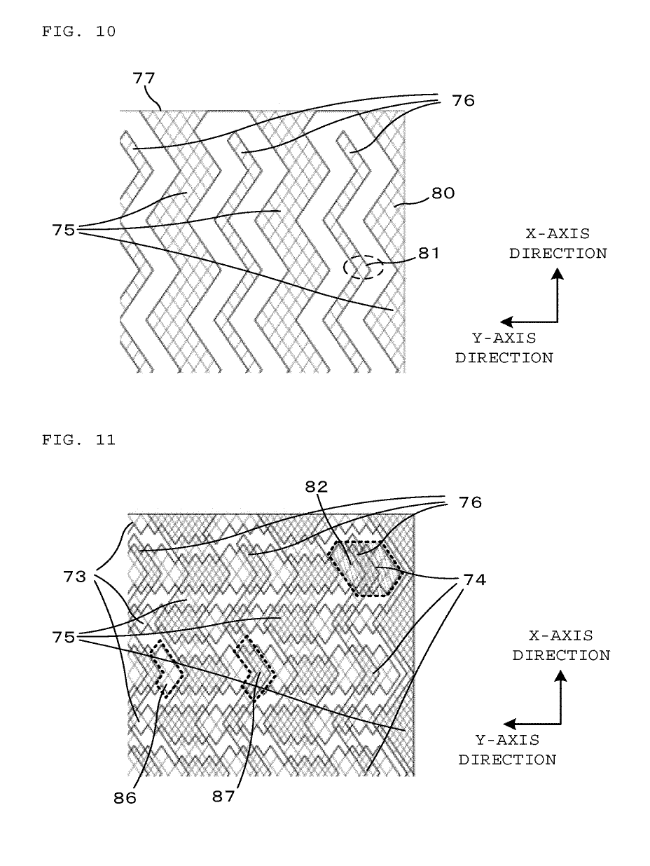

FIG. 10 is an enlarged view of a region B of the Y-axis wire section 12 in FIG. 8. According to FIG. 10, the other end of each of the Y-axis wire bodies 75 for electromagnetic induction is connected to and short-circuited with the common signal line 72 (*6), whereas the other end of each of the Y-axis wire bodies 76 for capacitance forms an open end, as described in FIG. 8.

Further, each of the Y-axis wire bodies, both the Y-axis wire bodies 75 for electromagnetic induction and the Y-axis wire bodies 76 for capacitance, has a mesh-like shape formed of a plurality of grids formed by a plurality of conductive axial wires 80 that intersect each other at predetermined intervals (4.5 μm, for example).

Further, each of the Y-axis wire bodies appears as a whole to be a roughly straight line. Each of the axial wire bodies in detail, however, includes acute-angle, right-angle, and obtuse-angle edge portions 81, and differently oriented edge portions 81 are alternately repeated to form a wave form.

In the capacitance-based detection, a Y-axis wire body 75 for electromagnetic induction located between Y-axis wire bodies 76 for capacitance blocks current and therefore lowers the capacitance in some cases. Therefore, to ensure more satisfactory detection sensitivity, the distance between a Y-axis wire body 75 and a Y-axis wire body 76 is preferably widened, as in the present embodiment. The width of the Y-axis wire bodies 76 for capacitance is therefore set to be narrower than the width of the Y-axis wire bodies 75 for electromagnetic induction, whereby a wider distance therebetween can be ensured.

<Specific configuration of specified position detection unit 10>

FIG. 11 shows a specific structure of the specified position detection sensor 10-1 of the specified position detection unit 10 in FIG. 3. According to FIG. 11, the X-axis wire section 11 shown in FIGS. 7 and 9 is overlaid on the Y-axis wire section 12 shown in FIGS. 8 and 10 via the substrate 13. The X-axis wire bodies that form the X-axis wire section 11 are configured to intersect the Y-axis wire bodies that form the Y-axis wire section 12 at right angles.

According to FIG. 11, there are regions 82, in each of which a Y-axis wire body 76 for capacitance in the Y-axis wire section 12 and an X-axis wire body 74 for capacitance in the X-axis wire section 11 are adjacent to each other in the upward/downward direction. An electrostatic field resulting from floating capacitance is formed around each of the regions 82, in which a Y-axis wire body 76 and an X-axis wire body 74 are adjacent to each other.

<Another example (example 1) of specified position detection sensor 10-1>

FIG. 12 is an enlarged view showing another example of the X-axis wire section. According to FIG. 12, each of the X-axis wire bodies, both the X-axis wire bodies 73 for electromagnetic induction and the X-axis wire bodies 74 for capacitance, has a mesh-like shape formed of a plurality of grids formed by a plurality of conductive axis wire bodies 79 that intersect each other at predetermined intervals (4.5 μm, for example), as in the example shown in FIG. 9.

Each of the X-axis wire bodies appears as a whole to be a roughly straight line. Each of the axial wire bodies in detail, however, includes acute-angle, right-angle, and obtuse-angle edge portions 81a, and differently oriented edge portions 81a are alternately repeated to form a wave form.

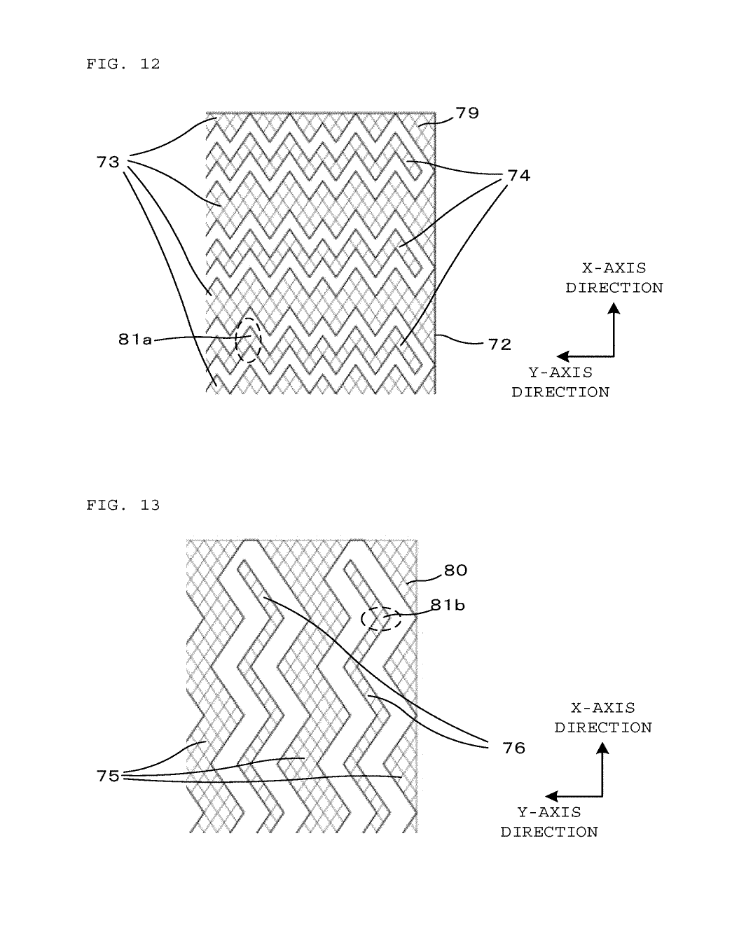

FIG. 13 is an enlarged view showing another example of the Y-axis wire section. According to FIG. 13, each of the Y-axis wire bodies, both the Y-axis wire bodies 75 for electromagnetic induction and the Y-axis wire bodies 76 for capacitance, has a mesh-like shape formed of a plurality of grids formed by a plurality of conductive axial wires 80 that intersect each other at predetermined intervals (4.5 μm, for example), as in the example in FIG. 10.

Each of the Y-axis wire bodies appears as a whole to be a roughly straight line. Each of the axial wire bodies in detail, however, includes acute-angle, right-angle, and obtuse-angle edge portions 81b, and differently oriented edge portions 81b are alternately repeated to form a wave form.

FIG. 14 shows another example of a specific structure of the specified position detection sensor 10-1. The X-axis wire section 11 shown in FIG. 12 is overlaid on the Y-axis wire section 12 shown in FIG. 13 via the substrate 13. The X-axis wire bodies that form the X-axis wire section 11 are configured to intersect the Y-axis wire bodies that form the Y-axis wire section 12 at right angles.

According to FIG. 14, there are regions 82, in each of which a Y-axis wire body 76 for capacitance in the Y-axis wire section 12 and an X-axis wire body 74 for capacitance in the X-axis wire section 11 are adjacent to each other in the upward/downward direction. An electrostatic field resulting from floating capacitance is formed around each of the regions 82, in which a Y-axis wire body 76 and an X-axis wire body 74 are adjacent to each other.

In the example in FIG. 14, a Y-axis wire body 76 for capacitance and an X-axis wire body 74 for capacitance are adjacent to each other over a wider range than in the example in FIG. 11. Further, since the portion where the X-axis wire body 74 and the Y-axis wire body 76 overlap with each other decreases, the floating capacitance decreases, which allows more sensitive detection.

<Another example (example 2) of specified position detection sensor 10-1>

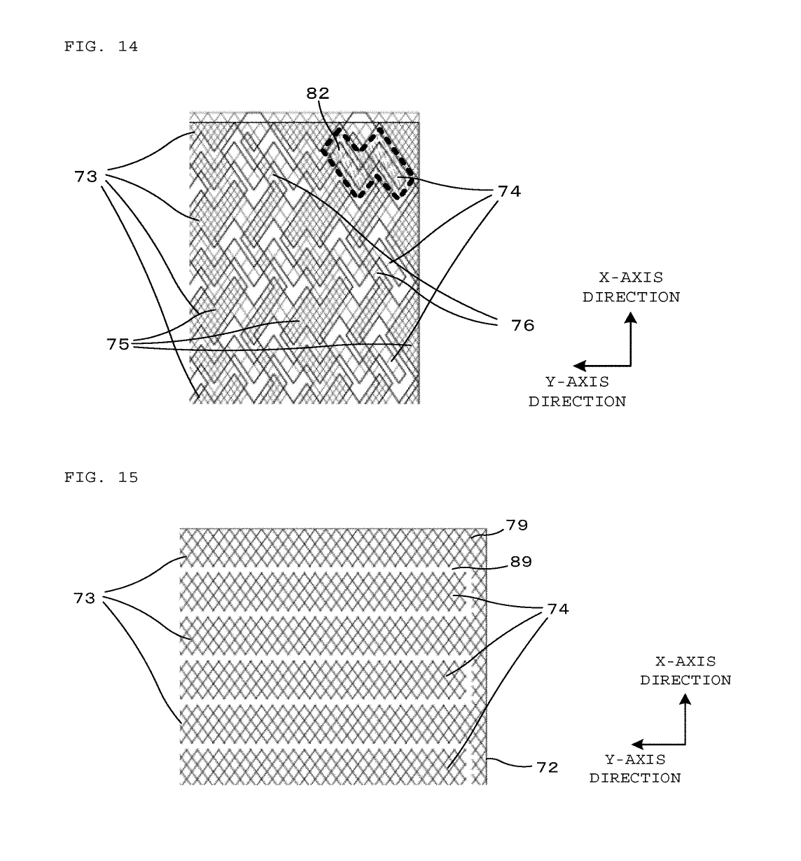

FIG. 15 is an enlarged view showing another example of the X-axis wire section. According to FIG. 15, each of the axial wire bodies, both the X-axis wire bodies 73 for electromagnetic induction and the X-axis wire bodies 74 for capacitance, has a mesh-like shape formed of a plurality of grids formed by a plurality of conductive axial wires 79 that intersect each other at predetermined intervals, as in the examples shown in FIGS. 9 and 12. In the examples shown in FIGS. 9 and 12, each of the axial wire bodies in detail has a wave shape, whereas in the example shown in FIG. 15, the distance between the crests of the wave is minimized (that is, distance corresponding to one grid) and each of the axial wire bodies is configured to be roughly a straight line. That is, the X-axis wire bodies are so formed that a gap portion 89 formed between an X-axis wire body 73 for electromagnetic induction and an X-axis wire body 74 for capacitance is roughly a straight line. The gap portions 89 are formed, for example, by placing a mask pattern on a resist applied on a predetermined film and exposing the resist to light followed by etching. The mask pattern may be a linear mask pattern (in the examples in FIGS. 9 and 12, a wave-shaped pattern corresponding to the wave shape needs to be used), allowing simplified manufacturing.

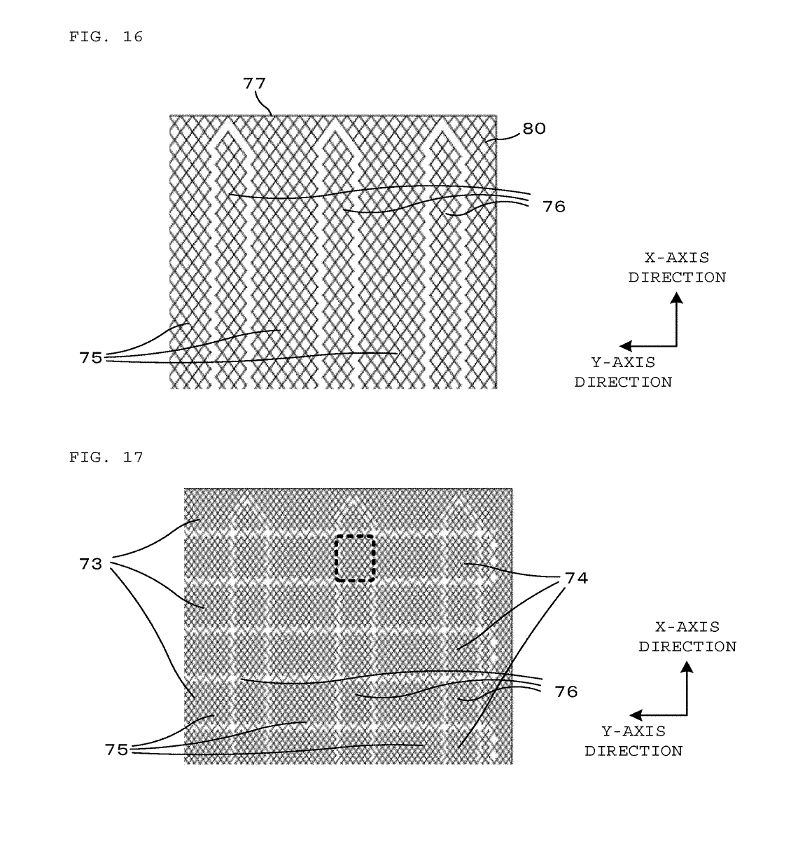

FIG. 16 is an enlarged view showing another example of the Y-axis wire section. FIG. 17 shows another example of a specific structure of the specified position detection sensor 10-1. Referring to FIGS. 16 and 17, the configuration of the Y-axis wire section is the same as those in the examples shown in FIGS. 10 and 13 and will therefore not be described. Further, the structure in which the X-axis wire section 11 and the Y-axis wire section 12 are overlaid on each other is also the same as those in the examples shown in FIGS. 11 and 14 except that the axial wire bodies of the X-axis wire section have different shapes and will therefore not be described. In the example shown in FIG. 17, only the X-axis wire bodies are straight lines. Of course, the Y-axis wire bodies can be straight lines, or both the X-axis wire bodies and the Y-axis wire bodies can be straight lines.

<Cross-sectional structure of specified position detection sensor 10-1>

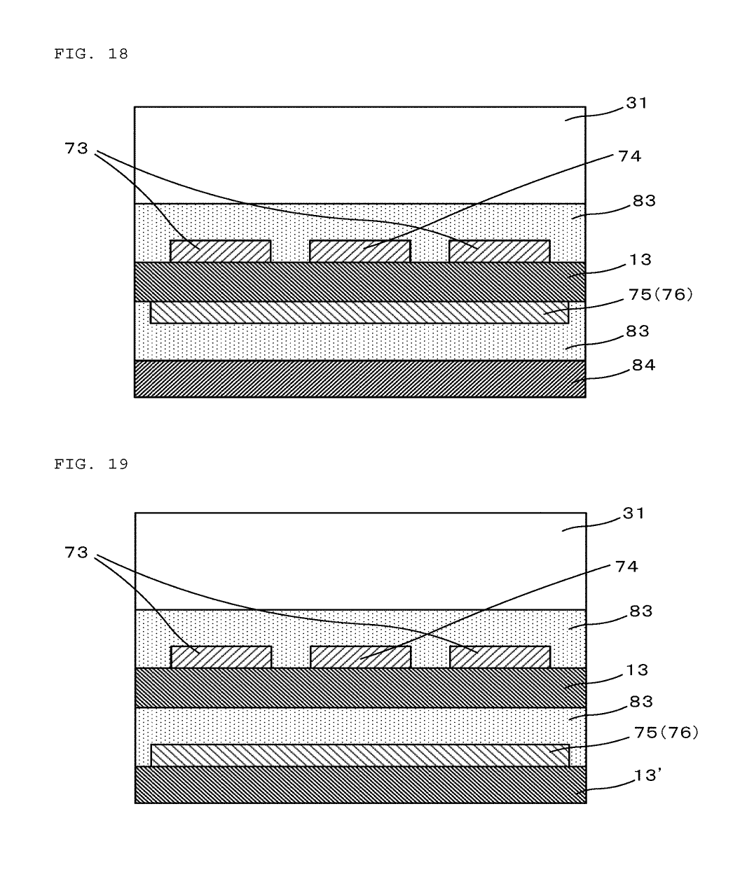

FIG. 18 is a schematic view showing an example of a cross section of the specified position detection sensor 10-1 of the specified position detection unit 10 in FIG. 3. Specifically, FIG. 18 is a cross-sectional view of the specified position detection sensor 10-1 taken along a Y-axis wire body in the X-axis direction, and FIG. 18 is simplified for convenience of description. FIG. 18 shows the protective layer section 31 as well as the specified position detection sensor 10-1 also for convenience of description.

According to FIG. 18, Y-axis wire bodies 75 for electromagnetic induction (Y-axis wire bodies 76 for capacitance depending on the position of the cross section) are disposed on the rear surface of the substrate 13. On the other hand, the X-axis wire bodies 73 for electromagnetic induction and the X-axis wire bodies 74 for capacitance are alternately arranged on the front surface of the substrate 13. The substrate 13 on both surfaces of which the axial wire bodies are disposed is glued to the protective layer section 31 via an adhesive section 83.

In the example shown in FIG. 18, the rear surface of the substrate 13 is glued to a protective film 84 via another adhesive section 83 but may instead be directly glued to the display section 30.

The substrate 13 can be made of a known substrate material as long as it is an insulating material. The substrate 13 can be made of polyethylene terephthalate (PET), polycarbonate (PC), or any other transparent film material by way of example.

Each of the axial wire bodies is formed of a conductive axial wire, and the conductive axial wire can be a graphite or carbon-based material; gold (Au), silver (Ag), copper (Cu), aluminum (Al), or any other metal, or an alloy thereof; ITO, a tin oxide, a zinc oxide, a cadmium oxide, a gallium oxide, a titanium oxide, or any other metal oxide; or any other known material.

In the example shown in FIG. 18, the description has been made of the case where the X-axis wire section 11 and the Y-axis wire section 12 are disposed on opposite sides of the substrate 13, but the configuration of the substrate and the axial wires is not, of course, limited thereto.

FIG. 19 is a schematic view showing another example of a cross section of the specified position detection sensor 10-1 of the specified position detection unit 10 in FIG. 3. That is, according to FIG. 19, the X-axis wire bodies 73 for electromagnetic induction and the X-axis wire bodies 74 for capacitance are also alternately arranged on the substrate 13 as in the example shown in FIG. 18. However, the specified position detection sensor 10-1 in FIG. 19 further includes a substrate 13′ on the side facing the rear surface of the substrate 13, and the Y-axis wire bodies 75 for electromagnetic induction (Y-axis wire bodies 76 for capacitance depending on the position of the cross section) are disposed on the front surface of the substrate 13′. The substrate 13 and the substrate 13′ are glued to each other via an adhesive section 83.

As described above, in the present embodiment, the axial wire bodies used to detect a specified position by using the electromagnetic induction method and the axial wire bodies used to detect a specified position by using the capacitance method are alternately arranged at predetermined intervals on the same surface of the same substrate. Whether a specified position is detected by using the electromagnetic induction method or the capacitance method is selected as appropriate by switching axial wire bodies to be turned on from one of the two types to the other as appropriate on the basis of the switch signal S10. The two specified position detection methods are therefore achieved on a signal substrate, whereby a variety of types of specified position detection can be achieved with a specified position detection unit having a simplified configuration.

### 2. Second Embodiment

A second embodiment of the present disclosure will be described. No description will be made of configurations having the same functions as those in the terminal device 1 and the specified position detection unit 10 according to the first embodiment described above. Part or entirety of the first embodiment, which has been described above, and the second embodiment, which will be described below, can be combined with each other as appropriate.

In the first embodiment, the description has been made of the case where the axial wire bodies are formed of a plurality of grids formed by a plurality of conductive axial wires that intersect each other at predetermined intervals. The present embodiment only differs from the first embodiment in that part of the axial wire bodies has an interpolation section in which conductive axial wires are arranged more densely than in the other portion of the axial wire bodies.

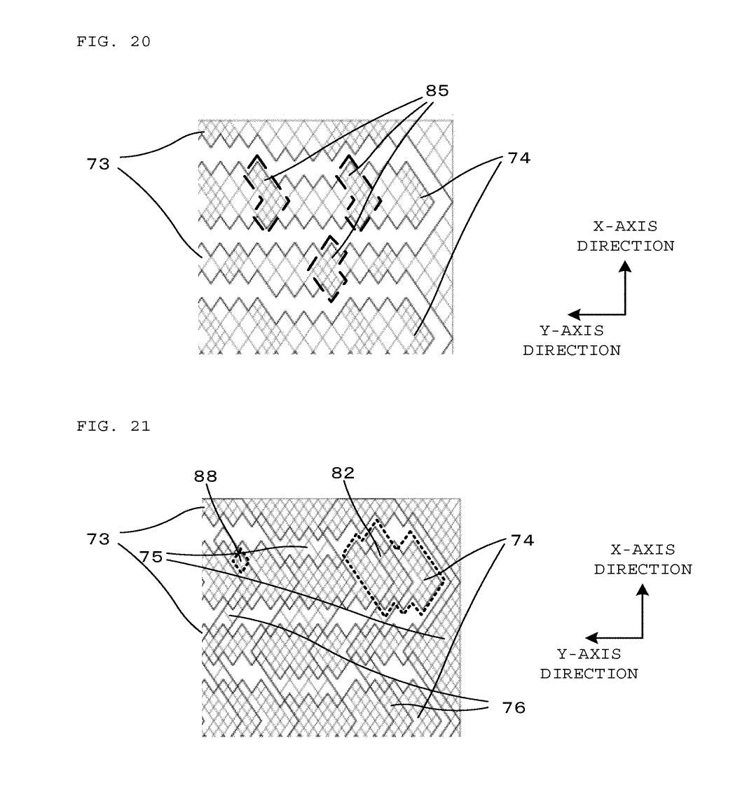

FIG. 20 is an enlarged view of an X-axis wire section 11 according to the second embodiment of the present disclosure. According to FIG. 20, the other end of each of the X-axis wire bodies 73 for electromagnetic induction is connected to and short-circuited with the common signal line 72 and the other end of each of the X-axis wire bodies 74 for capacitance forms an open end.

Each of the X-axis wire bodies, both the X-axis wire bodies 73 for electromagnetic induction and the X-axis wire bodies 74 for capacitance, has a mesh-like shape formed of a plurality of grids formed by plurality of conductive axial wires 79 that interest each other at predetermined intervals (4.5 μm, for example).

In addition, each of the X-axis wire bodies has conductive axial wires 79 added in the grids formed at the predetermined intervals and therefore includes an interpolation section 85, which is formed of a plurality of grids formed by the conductive axial wires that intersect each other at intervals narrower than predetermined intervals. In the example shown in FIG. 20, a plurality of interpolation sections 85 are provided at a predetermined cycle in the X-axis wire bodies 73 for electromagnetic induction. Further, a plurality of interpolation sections 85 are provided at a predetermined cycle also in the X-axis wire bodies 74 for capacitance.

FIG. 21 shows a specific structure of the specified position detection sensor 10-1 according to the second embodiment of the present disclosure. According to FIG. 21, the X-axis wire section 11 is overlaid on the Y-axis wire section 12 via the substrate 13, as in the first embodiment. The X-axis wire bodies that form the X-axis wire section 11 are configured to intersect the Y-axis wire bodies that form the Y-axis wire section 12 at right angles. As clearly shown in FIG. 21, when the X-axis wire section 11 and the Y-axis wire section 12 are overlaid on each other, individual grids 88, which are formed by the axial wires that form the X-axis wire section 11 and the Y-axis wire section 12, have roughly uniform widths and sizes (For example, in the example shown in FIG. 11 (*7), grids 86 each having a wide width and grids 87 each having a narrow width are present). In other words, the interpolation sections 85 are formed in the X-axis wire section 11 and/or the Y-axis wire section 12 in such a way that when the X-axis wire section 11 and the Y-axis wire section 12 are overlaid on each other, the individual grids 88 formed by the axial wires that form the X-axis wire bodies and the Y-axis wire bodies have roughly uniform widths. When each of the axial wires is made of an opaque material, the user who views the display section formed of a non-uniform grid pattern may undesirably recognize the non-uniform portion to be a patterned portion in some cases. The present embodiment avoids the situation described above and improves visibility of the display section.

On the other hand, each of the Y-axis wire bodies according to the present embodiment has the interpolation sections 85, as described with reference to FIG. 20. Therefore, when the Y-axis wire section 12 is overlaid on the X-axis wire section, an electrostatic field resulting from floating capacitance is formed around each of the regions 82, where an X-axis wire body and a Y-axis wire body are adjacent to each other in the upward/downward direction, which lowers wiring resistance of each of the axial wires, whereby more sensitive detection is achieved.

In the present embodiment, the description has been made of the case where the interpolation sections 85 are provided in the X-axis wire section 11. The interpolation sections 85 can, of course, be provided in the Y-axis wire section 12 or in both the axial wire sections as appropriate and as required.

As described above, in the present embodiment, the axial wire bodies used to detect a specified position by using the electromagnetic induction method and the axial wire bodies used to detect a specified position by using the capacitance method are alternately arranged at predetermined intervals on the same surface of the same substrate. Whether a specified position is detected by using the electromagnetic induction method or the capacitance method is selected as appropriate by switching axial wire bodies to be turned on from one of the two types to the other as appropriate on the basis of the switch signal S10. The two specified position detection methods are therefore achieved on a signal substrate, whereby a variety of types of specified position detection can be achieved with a specified position detection unit having a simplified configuration.

Further, since at least part of the axial wire bodies is provided with the interpolation sections 85, wiring resistance of the axial wire bodies is lowered, whereby more sensitive detection is achieved. Moreover, the interpolation sections 85 are so provided that when the X-axis wire section 11 and the Y-axis wire section 12 are overlaid on each other, the individual grids 88 formed by the axial wires that form the X-axis wire bodies and the Y-axis wire bodies have roughly uniform widths. The configuration improves visibility the display section viewed by the user.

### 3. Others

In each of the embodiments described above, the description has been made of the case where the axial wire bodies are formed by a grid pattern formed by a plurality of conductive axial wires, but the present disclosure is, of course, not limited to the embodiments. For example, what is called a diamond pattern, in which diamond shapes are concatenated with each other in series, may be employed.

In each of the embodiments described above, the specified position detection using the electromagnetic induction method and the specified position detection using the capacitance method can be so selected that they are switched from one to the other. The selection is performed in the same manner as in the methods described in International patent application Nos. PCT/JP2013/007081 and PCT/JP2014/069668. The entirety of the contents described in PCT/JP2013/007081 and PCT/JP2014/069668 are therefore incorporated herein by reference.

### KEY

1 Terminal device

10 Specified position detection unit

11 X-axis wire section

12 Y-axis wire section

14 Drive signal output section

15 Position detection signal output section

16 Specified position detection controller

20 Central processing unit

30 Display section

1. A specified position detection unit comprising:
a first input-side axial wire section that is disposed on a predetermined substrate and includes a plurality of axial wire bodies each having an end to which drive current is supplied and another end which is short-circuited;
a second input-side axial wire section that is disposed on the substrate on which the first input-side axial wire section is disposed and includes a plurality of axial wire bodies each having an end to which drive voltage is supplied and another end which is open; and
a drive signal output section that outputs the drive current to the first input-side axial wire section and the drive voltage to the second input-side axial wire section.

2. The specified position detection unit according to claim 1, wherein the axial wire bodies contained in the first input-side axial wire section are connected at the other end to at least one other axial wire body contained in the first input-side axial wire section, and forms an input loop coil for specified position detection by using electromagnetic induction.

3. The specified position detection unit according to claim 1, wherein each of the axial wire bodies contained in the second input-side axial wire section is an axial wire body for specified position detection using capacitance.

4. The specified position detection unit according to claim 1, wherein the axial wire bodies contained in the first input-side axial wire section and the axial wire bodies contained in the second input-side axial wire section are alternately arranged on a first surface of the substrate.

5. The specified position detection unit according to claim 1, further comprising:
a first output-side axial wire section including a plurality of axial wire bodies each having an end through which a first detection signal is outputted and another end which is short-circuited; and
a second output-side axial wire section including a plurality of axial wire bodies each having an end through which a second detection signal is outputted and another end which is open.

6. The specified position detection unit according to claim 5, wherein the axial wire bodies contained in the first output-side axial wire section and the axial wire bodies contained in the second output-side axial wire section are alternately arranged on a second surface of the substrate.

7. The specified position detection unit according to claim 5, wherein the axial wire bodies contained in the first output-side axial wire section and the axial wire bodies contained in the second output-side axial wire section are alternately arranged on another substrate different from the substrate.

8. The specified position detection unit according to claim 1, wherein each of the axial wire bodies is formed of a plurality of grids formed by a plurality of conductive axial wires that intersect each other at predetermined intervals.

9. The specified position detection unit according to claim 1,
wherein each of the axial wire bodies is formed of a plurality of grids formed by a plurality of conductive axial wires that intersect each other at predetermined intervals, and
at least part of the axial wire bodies includes an interpolation section comprising a plurality of grids formed by conductive axial wires that intersect each other at intervals narrower than the predetermined intervals.

10. A specified position detection sensor comprising:
a first input-side axial wire section that is disposed on a predetermined substrate and includes a plurality of axial wire bodies each having an end to which drive current is supplied and another end which is short-circuited; and
a second input-side axial wire section that is disposed on the substrate on which the first input-side axial wire section is disposed and includes a plurality of axial wire bodies each having an end to which drive voltage is supplied and another end which is open.

11. A terminal device comprising:
a first input-side axial wire section that is disposed on a predetermined substrate and includes a plurality of axial wire bodies each having an end to which drive current is supplied and another end which is short-circuited;
a second input-side axial wire section that is disposed on the substrate on which the first input-side axial wire section is disposed and includes a plurality of axial wire bodies each having an end to which drive voltage is supplied and another end which is open; and
a drive signal output section that outputs the drive current to the first input-side axial wire section and the drive voltage to the second input-side axial wire section.
